(19) United States
(12) Patent Application Publication
(10) Pub. No.: US 2008/0146332 A1
(43) Pub. Date: Jun. 19, 2008

(54) Gaming machine and control method thereof

(75) Inventor: Kazumasa Yoshizawa, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: ARUZE CORP., Tokyo (JP)

(21) Appl. No.: 12/000,454

(22) Filed: Dec. 12, 2007

(30) Foreign Application Priority Data
Dec. 14, 2006 (JP) JP2006-337190

(51) Int. Cl. A63F 13/00

(52) U.S. Cl. 463/31

(57) ABSTRACT

A gaming machine provides a first game and a second game different from the first game. The gaming machine has a first display that displays a plurality of symbols and a plurality of pins; a second display that displays a plurality of pins; and a processor. The processor operates: to control the first display to variably display and then to stop the symbols in the first game; to determine a winning of the first game in accordance with the stopped symbols; to control each of the first and second displays to display an image that a ball is moved between the first and second displays while colliding with the pins, in the second game; and to award a payout about the second game when the ball reaches a predetermined location.

### CROSS REFERENCE TO RELATED APPLICATION

This application is based upon and claims the benefit of priority from the prior Japanese Patent Application No. 2006-337190, filed on Dec. 14, 2006, the entire contents of which are incorporated herein by reference.

### BACKGROUND OF THE INVENTION

1. Field of the Invention

The invention relates to a gaming machine that executes one effect using several displays and a control method thereof.

2. Description of Related Art

When a player inserts a game medium such as coin or bill into an insertion slot of a gaming machine and presses a spin button, symbols are scroll-displayed in a display mounted on a front of a cabinet and the respective symbols are then stopped automatically.

According to the above gaming machine, for example, when the symbols stopped on a payline constitute a predetermined combination, the predetermined number of game media are paid out (refer to U.S. Pat. No. 6,604,999 B2, U.S. Patent No. 2002065124A1). In addition, when a certain symbol referred to as scattered symbol is displayed on the display after the scroll, the predetermined number of game media are paid out in accordance with the number of scattered symbols displayed, irrespective of the payline.

### SUMMARY OF THE INVENTION

The above gaming machine provides a player with a base game and a bonus game that is more advantageous to the player than the base game. In the bonus game, in the display, it is displayed, as an effect, an image that balls are successively thrown toward a basket. When a predetermined number of the balls are put in the basket, a payout is awarded. Herein, when the bonus game is started, the number of the balls, which are put in the basket, is determined in advance and an effect is made in accordance with the determined result. Since the ball is shot in a straight line form, the moving of the ball being put in the basket may be unnatural. Due to the unnatural movement of the ball, it is certain that the payout is not accidentally awarded. As a result, an interest in the game may be lost.

The invention is to provide a gaming machine that provides with a player with an impression as if a payout were accidentally awarded, thereby suppressing an interest in a game from being lost, and a control method thereof.

According to a first aspect of the invention, there is provided a gaming machine that provides a first game and a second game different from the first game, the gaming machine comprising: a first display that displays a plurality of symbols and a plurality of pins; a second display that displays a plurality of pins; and a processor. The processor operates: to control the first display to variably display and then to stop the symbols in the first game; to determine a winning of the first game in accordance with the stopped symbols; to control each of the first and second displays to display an image that a ball is moved between the first and second displays while colliding with the pins, in the second game; and to award a payout about the second game when the ball reaches a predetermined location.

According to a second aspect of the invention, there is provided a gaming machine that provides a first game and a second game different from the first game, the gaming machine comprising: a first display that displays a plurality of symbols and a plurality of pins; a second display that displays a plurality of pins; a memory that stores a plurality of effect images having different conditions about the pins; and a processor. The processor to operates: to control the first display to variably display and then to stop the symbols in the first game; to determine a winning of the first game in accordance with the stopped symbols; to select, from the effect images stored in the memory, an effect image to be displayed in the first display and an effect image to be displayed in the second display, respectively, and to control each of the first and second displays to display an image that a ball is moved between the selected effect images while colliding with the pins, in the second game; and to award a payout about the second game when the ball reaches a predetermined location.

According to a third aspect of the invention, there is provided a gaming machine that provides a first game and a second game different from the first game, the gaming machine comprising: a first display that displays a plurality of symbols and a plurality of pins; a second display that displays a plurality of pins; a memory that stores a plurality of effect images having different conditions about the pins; and a processor. The processor operates: to control the first display to variably display and then to stop the symbols in the first game; to determine a winning of the first game in accordance with the stopped symbols; to select, from the effect images stored in the memory, an effect image to be displayed in the first display and an effect image to be displayed in the second display, respectively, in accordance with a payout amount about the second game, and to control each of the first and second displays to display an image that a ball is moved between the selected effect images while colliding with the pins, in the second game; and to award a payout about the second game when the ball reaches a predetermined location.

According to a fourth aspect of the invention, there is provided a control method of a gaming machine comprising the steps of: controlling a first display to variably display and then to stop a plurality of symbols in a first game; determining a winning of the first game in accordance with the symbols stopped in the first display; controlling each of the first display and a second display different from the first display to display an image that a ball is moved between the first display and the second display while colliding with a plurality of pins, in a second game different from the first game; and awarding a payout about the second game when the ball reaches a predetermined location.

According to a fifth aspect of the invention, there is provided a control method of a gaming machine comprising the steps of: controlling a first display to variably display and then to stop a plurality of symbols in a first game; determining a winning of the first game in accordance with the symbols stopped in the first display; selecting, from a plurality of effect images having different conditions about pins, an effect image to be displayed in the first display and an effect image to be displayed in a second display different from the first display, respectively, and controlling each of the first display and the second display to display an image that a ball is moved between the selected effect images while colliding with the pins, in a second game different from the first game; and awarding a payout about the second game when the ball reaches a predetermined location.

According to a sixth aspect of the invention, there is provided a control method of a gaming machine comprising the steps of: controlling a first display to variably display and then to stop a plurality of symbols in a first game; determining a winning of the first game in accordance with the symbols stopped in the first display; selecting, from a plurality of effect images having different conditions about pins, an effect image to be displayed in the first display and an effect image to be displayed in a second display different from the first display, respectively, in accordance with a payout amount about a second game different from the first game and controlling each of the first display and the second display to display an image that a ball is moved between the selected effect images while colliding with the pins, in the second game; and awarding a payout about the second game when the ball reaches a predetermined location.

According to the first to sixth aspects of the invention, in the second game, it is displayed that the ball is moved while colliding with the pins. Thereby, even though the location is determined in advance which the ball reaches, the moving direction of the ball after the collision with the pins is adjusted, so that the ball reaches a predetermined location in a natural moving manner. As a result, a player is impressed as if a payout were accidentally awarded, so that an interest in a game is suppressed from being lost.

According to a seventh aspect of the invention, there is provided a gaming machine that provides a first game and a second game different from the first game, the gaming machine comprising: a first display that displays a plurality of symbols and a plurality of pins; a second display that displays a plurality of pins; and a processor. The processor operates: to control the first display to variably display and then to stop the symbols in the first game; to determine a winning of the first game in accordance with the stopped symbols; to control each of the first and second displays to display an image that a ball is moved between the first and second displays while colliding with the pins and an image that a receiver is moved, in the second game; and to award a payout about the second game when the ball reaches a predetermined location.

According to a eighth aspect of the invention, there is provided a gaming machine that provides a first game and a second game different from the first game, the gaming machine comprising: a first display that displays a plurality of symbols and a plurality of pins; a second display that displays a plurality of pins; a memory that stores a plurality of effect images having different conditions about the pins and a receiver; and a processor. The processor operates: to control the first display to variably display and then to stop the symbols, in the first game; to determine a winning of the first game in accordance with the stopped symbols; to select, from the effect images stored in the memory, an effect image to be displayed in the first display and an effect image to be displayed in the second display, respectively, and to control each of the first and second displays to display an image that a ball is moved between the selected effect images while colliding with the pins and an image that the receiver is moved, in the second game; and to award a payout about the second game when the ball reaches a predetermined location.

According to a ninth aspect of the invention, there is provided a gaming machine that provides a first game and a second game different from the first game, the gaming machine comprising: a first display that displays a plurality of symbols and a plurality of pins; a second display that displays a plurality of pins; a memory that stores a plurality of effect images having different conditions about the pins and a receiver; and a processor that operates: to control the first display to variably display and then to stop the symbols in the first game; to determine a winning of the first game in accordance with the stopped symbols; to select, from the effect images stored in the memory, an effect image to be displayed in the first display and an effect image to be displayed in the second display, respectively, in accordance with a payout amount about the second game, and to control each of the first and second displays to display an image that a ball is moved between the selected effect images while colliding with the pins and an image that the receiver is moved, in the second game; and to award a payout about the second game when the ball reaches a predetermined location.

According to a tenth aspect of the invention, there is provided a control method of a gaming machine comprising the steps of: controlling a first display to variably display and then to stop a plurality of symbols in a first game; determining a winning of the first game in accordance with the symbols stopped in the first display; controlling each of the first display and a second display different from the first display to display an image that a ball is moved between the first display and the second display while colliding with the pins and an image that a receiver is moved, in a second game different from the first game; and awarding a payout about the second game when the ball reaches a predetermined location.

According to a eleventh aspect of the invention, there is provided a control method of a gaming machine comprising the steps of: controlling a first display to variably display and then to stop a plurality of symbols in a first game; determining a winning of the first game in accordance with the symbols stopped in the first display; selecting, from a plurality of effect images having different conditions about pins and a receiver, an effect image to be displayed in the first display and an effect image to be displayed in a second display different from the first display, respectively, and controlling each of the first display and the second display to display an image that a ball is moved between the selected effect images while colliding with the pins and an image that the receiver is moved, in a second game different from the first game; and awarding a payout about the second game when the ball reaches a predetermined location.

According to a twelfth aspect of the invention, there is provided a control method of a gaming machine comprising the steps of: controlling a first display to variably display and then to stop a plurality of symbols in a first game; determining a winning of the first game in accordance with the symbols stopped in the first display; selecting, from a plurality of effect images having different conditions about pins and a receiver, an effect image to be displayed in the first display and an effect image to be displayed in a second display different from the first display, respectively, in accordance with a payout amount about a second game different from the first game and controlling each of the first display and the second display to display an image that a ball is moved between the selected effect images while colliding with the pins and an image that the receiver is moved, in the second game; and awarding a payout about the second game when the ball reaches a predetermined location.

According to the seventh to twelfth aspects of the invention, in the second game, as the first to sixth aspects, it is displayed that the ball is moved while colliding with the pins and it is displayed that the receiver is moved. Thereby, even though it is determined in advance whether the ball is received in the receiver, the moving direction of the ball after the collision with the pins is adjusted and the moving speed of the receiver is adjusted, so that the movement of the ball regarding whether the ball is received in the receiver becomes natural. As a result, a player is impressed as if a payout were accidentally awarded, so that an interest in a game is suppressed from being lost.

According to a thirteenth aspect of the invention, there is provided a gaming machine that provides a first game and a second game different from the first game, the gaming machine comprising: a first display that displays a plurality of symbols and a plurality of pins; a second display that displays a plurality of pins; and a processor. The processor operates: to control the first display to variably display and then to stop the symbols in the first game; to determine a winning of the first game in accordance with the stopped symbols; to control each of the first and second displays to display an image that a ball is moved between the first and second displays while colliding with the pins and an image that a receiver and an inhibitor inhibiting the ball from being received in the receiver are moved, in the second game; and to award a payout about the second game when the ball reaches a predetermined location.

According to a fourteenth aspect of the invention, there is provided a gaming machine that provides a first game and a second game different from the first game, the gaming machine comprising: a first display that displays a plurality of symbols and a plurality of pins; a second display that displays a plurality of pins; a memory that stores a plurality of effect images having different conditions about the pins, a receiver and an inhibitor inhibiting the ball from being received in the receiver; and a processor. The processor operates: to control the first display to variably display and then to stop the symbols in the first game; to determine a winning of the first game in accordance with the stopped symbols; to select, from the effect images stored in the memory, an effect image to be displayed in the first display and an effect image to be displayed in the second display, respectively, and to control each of the first and second displays to display an image that a ball is moved between the selected effect images while colliding with the pins and an image that the receiver and the inhibitor are moved, in the second game; and to award a payout about the second game when the ball reaches a predetermined location.

According to a fifteenth aspect of the invention, there is provided gaming machine that provides a first game and a second game different from the first game, the gaming machine comprising: a first display that displays a plurality of symbols and a plurality of pins; a second display that displays a plurality of pins; a memory that stores a plurality of effect images having different conditions about the pins, a receiver and an inhibitor inhibiting the ball from being received in the receiver; and a processor. The processor operates: to control the first display to variably display and then to stop the symbols in the first game; to determine a winning of the first game in accordance with the stopped symbols; to select, from the effect images stored in the memory, an effect image to be displayed in the first display and an effect image to be displayed in the second display, respectively, in accordance with a payout amount about the second game, and to control each of the first and second displays to display an image that a ball is moved between the selected effect images while colliding with the pins and an image that the receiver and the inhibitor are moved, in the second game; and to award a payout about the second game when the ball reaches a predetermined location.

According to a sixteenth aspect of the invention, there is provided a control method of a gaming machine comprising the steps of: controlling a first display to variably display and then to stop a plurality of symbols in a first game; determining a winning of the first game in accordance with the symbols stopped in the first display; controlling each of the first display and a second display different from the first display to display an image that a ball is moved between the first display and the second display while colliding with the pins and an image that a receiver and an inhibitor inhibiting the ball from being received in the receiver are moved, in a second game different from the first game; and awarding a payout about the second game when the ball reaches a predetermined location.

According to a seventeenth aspect of the invention, there is provided a control method of a gaming machine comprising the steps of: controlling a first display to variably display and then to stop a plurality of symbols in a first game; determining a winning of the first game in accordance with the symbols stopped in the first display; selecting, from a plurality of effect images having different conditions about pins, a receiver and an inhibitor inhibiting a ball from being received in the receiver, an effect image to be displayed in the first display and an effect image to be displayed in a second display different from the first display, respectively, and controlling each of the first display and the second display to display an image that a ball is moved between the selected effect images while colliding with the pins and an image that the receiver and the inhibitor are moved, in a second game different from the first game; and awarding a payout about the second game when the ball reaches a predetermined location.

According to a eighteenth aspect of the invention, there is provided a control method of a gaming machine comprising the steps of: controlling a first display to variably display and then to stop a plurality of symbols in a first game; determining a winning of the first game in accordance with the symbols stopped in the first display; selecting, from a plurality of effect images having different conditions about pins, a receiver and an inhibitor inhibiting a ball from being received in the receiver, an effect image to be displayed in the first display and an effect image to be displayed in a second display different from the first display, respectively, in accordance with a payout amount about a second game different from the first game and controlling each of the first display and the second display to display an image that a ball is moved between the selected effect images while colliding with the pins and an image that the receiver and the inhibitor are moved, in the second game; and awarding a payout about the second game when the ball reaches a predetermined location.

In the thirteenth to eighteenth aspects of the invention, as the first to twelfth aspects, it is displayed that the ball is moved while colliding with the pins and it is displayed that the receiver and the inhibitor are moved. Thereby, even though it is determined in advance whether the ball is received in the receiver, the moving direction of the ball after the collision with the pins is adjusted and the moving speed of the receiver and the inhibitor is adjusted, so that the movement of the ball regarding whether the ball is received in the receiver becomes natural. As a result, a player is impressed as if a payout were accidentally awarded, so that an interest in a game is suppressed from being lost.

### BRIEF DESCRIPTION OF THE DRAWINGS

Other and further objects, features and advantages of the invention will appear more fully from the following description taken in connection with the accompanying drawings, in which:

FIG. 1 is a perspective view showing an external appearance of a gaming machine according to an embodiment of the invention;

FIG. 2 shows an example of an image that is displayed in a center display of a gaming machine in a base game;

FIG. 3 shows a data table of symbols depicted on each reel;

FIG. 4, FIG. 5 and FIG. 6 show examples of an effect image that is displayed in each of a center display and an upper display of a gaming machine in a bonus game;

FIG. 7 and FIG. 8 are block diagrams showing an electrical structure of a gaming machine;

FIG. 9 shows an upper effect image managing table;

FIG. 10 shows a central effect image managing table;

FIG. 11 is a flow chart showing a game process that is executed by a gaming machine; and

FIG. 12 is a flow chart showing a bonus game process that is executed by a gaming machine.

### DESCRIPTION OF THE PREFERRED EMBODIMENTS

Hereinafter, it will be described an embodiment of a gaming machine according to the invention with reference to the drawings.

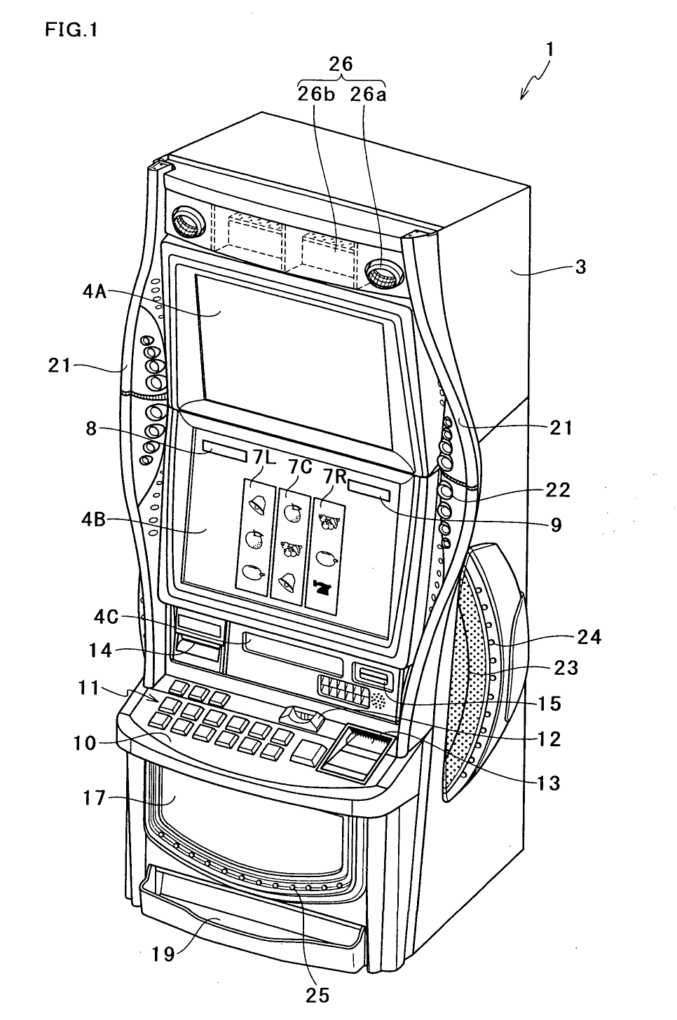

As shown in FIG. 1, a gaming machine 1 according to an embodiment of the invention is equipped in a game arcade such as casino, and provides a player with a base game and a bonus game that is more advantageous to the player than the base game. The gaming machine 1 has a cabinet 3 that is longitudinally long. To a front face of the cabinet are provided an upper display 4A, a center display 4B and a sub display 4C.

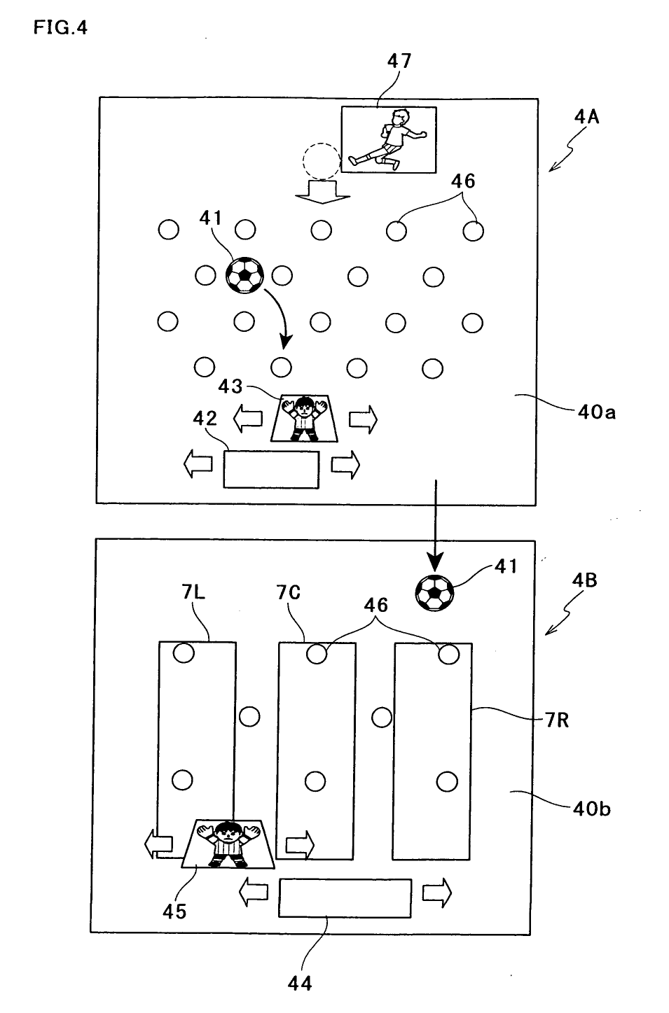

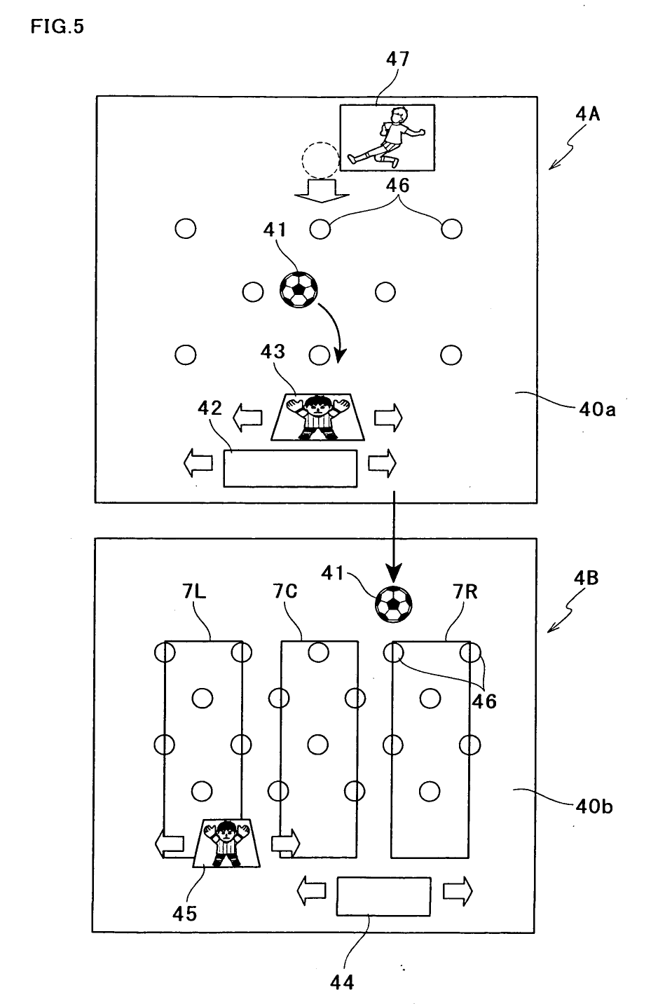

The upper display 4A has a transparent liquid crystal panel fixed to a front door of the cabinet 3 and displays an upper effect image 40a (refer to FIGS. 4 to 6) in a bonus game, which will be described later.

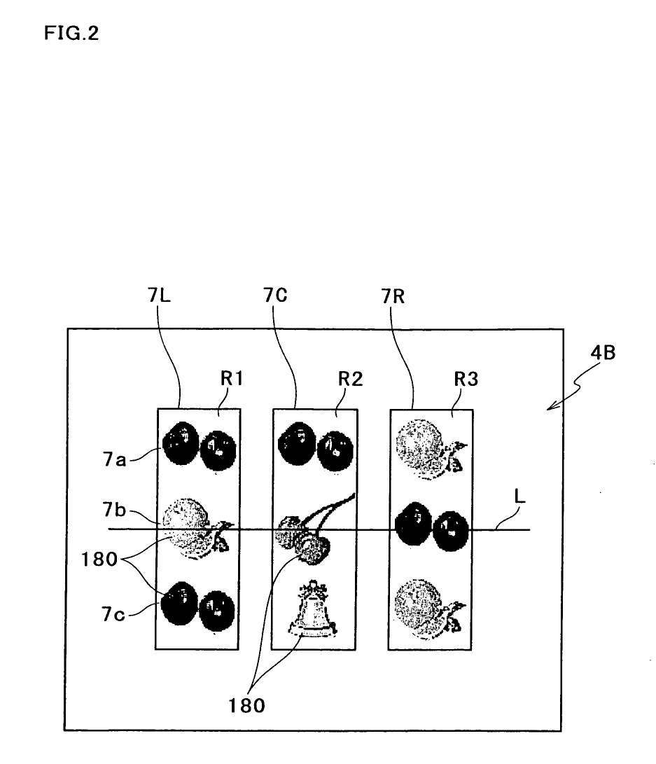

The center display 4B also has a transparent liquid crystal panel that is fixed to the front door of the cabinet 3. In a base game, the center display 4B performs a display as shown in FIGS. 1 and 2. To be more specific, as shown in FIG. 2, the center display 4B is provided with 3 (three) transparent display windows 7L, 7C, 7R. A player plays a base game while seeing the scroll of symbols 180 depicted on peripheries of reels R1, R2, R3 disposed in the cabinet 3. Each of the display windows 7L, 7C, 7R is divided into an upper stage 7a, a central stage 7b and a lower stage 7c. At the time when the scroll display is ended in the base game, the symbols 180 are stopped in the respective upper stage 7a, central stage 7b and lower stage 7c. Accordingly, the display windows 7L, 7C, 7R display the symbols 180 in a matrix type of 3 columns/3 rows. For example, in FIG. 2, “PLUM” is stopped in the upper stage 7a of the display window 7L, “ORANGE” is stopped in the central stage 7b of the display window 7L and “PLUM” is stopped in the lower stage 7c of the display window 7L.

A payline L is provided which horizontally traverses the central stages 7b of the display windows 7L, 7C, 7R. A winning is determined depending on a combination of the symbols 180 stopped on the payline L. When a winning is made, a payout is awarded or a game state is shifted to a bonus game, in accordance with a combination of the symbols on the payline L. The “payout” means awarding a game medium to a player. The game medium may include the credits to be stored in the gaming machine 1, in addition to a coin.

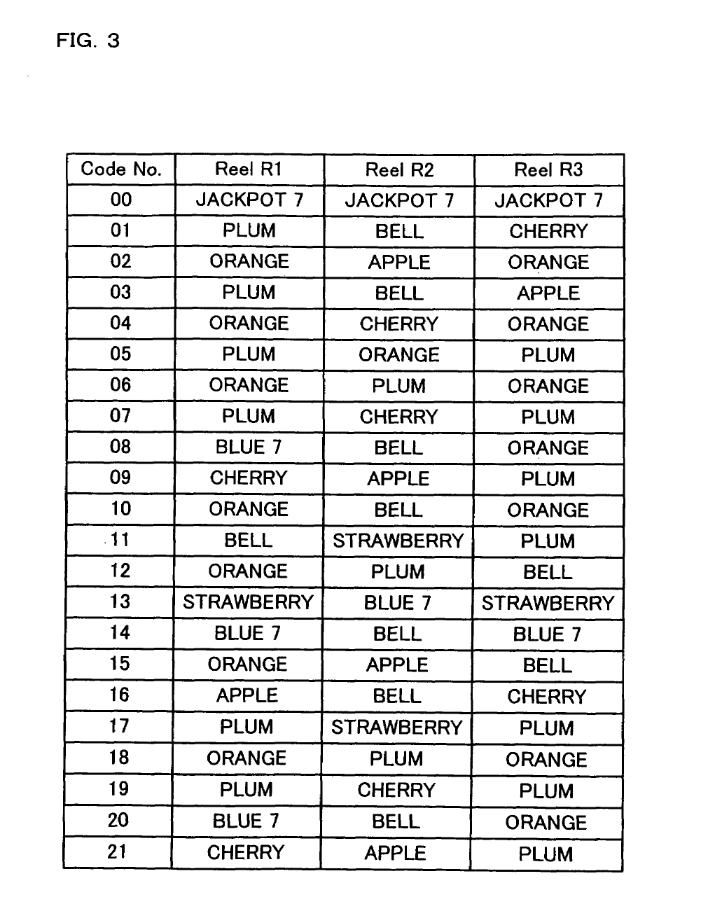

The symbols 180 include 8 (eight) types of “JACKPOT 7,” “BLUE 7,” “BELL,” “CHERRY,” “STRAWBERRY,” “PLUM,” “ORANGE” and “APPLE.” As shown in FIG. 3, 22 symbols 180 are depicted in a line on the peripheries of the respective reels R1, R2, R3 in different orders and combinations. The symbols depicted on the respective reels R1, R2, R3 are given with code numbers of 0˜21 in an order.

For example, when a symbol of “APPLE” is arranged on the payline L, the game state is shifted to a bonus game. When a symbol of “CHERRY” is arranged on the payline L, 20 coins are paid out per one bet. When a symbol of “PLUM” is arranged on the payline L, 5 coins are paid out per one bet.

For example, in each of the gaming machines 1 connected to a network, a predetermined percentage of the amount of money bet every game may be accumulated. When a symbol of “JACKPOT 7” is arranged on the payline L, the accumulated amount of money, i.e., jackpot may be paid out. In addition, in a bonus game, all or a part of the jackpot may be paid out.

Back to FIG. 1, a payout-number indicator 8 and a credit-number indicator 9 are disposed in the center display 4B. The center display 4B also displays a moving picture to carry out an effect when a winning is made.

The center display 4B displays a central effect image 40b (refer to FIGS. 4 to 6) in a bonus game. A player plays a bonus game while seeing an upper effect image 40a displayed in the upper display 4A and a central effect image 40b displayed in the center display 4B.

Here, examples of the effect images 40a, 40b will be described with reference to FIGS. 4 to 6.

Firstly, the upper effect image 40a is described. In the upper effect image 40a shown in FIGS. 4 and 5, a soccer player 47, pins 46 arranged in a predetermined distance, a receiver 42 corresponding to a soccer ball and an inhibitor 43 corresponding to a goalkeeper are displayed. Although the soccer player 47, the pins 46 and receiver 42 are displayed in the upper effect image 40a shown in FIG. 6, the inhibitor 43 is not displayed. In this embodiment, the upper effect image 40a includes 16 types. The number of the pins 46, with or without the receiver 42, the size of the receiver 42, with or without the inhibitor 43 and size of the inhibitor 43 are different for each type. For example, the number of the pins 46 is same in the upper effect images 40a of FIGS. 4 and 6. However, the number of the pins 46 displayed in the upper effect image 40a of FIG. 5 is smaller than those of the pins 46 displayed in the upper effect image 40a of FIGS. 4 and 6. The size of the receiver 42 is same in the upper effect images 40a of FIGS. 4 and 6. However, the size of the receiver 42 displayed in the upper effect image 40a of FIG. 4 is smaller than those of the receivers 42 displayed in the upper effect images 40a of FIGS. 5 and 6. The size of the inhibitor 43 is larger in FIG. 5 than in FIG. 4.

Then, the central effect image 40b is described. In each central effect image 40b shown in FIGS. 4 to 6, pins 46 arranged in a predetermined distance, a receiver 44 corresponding to a soccer ball and an inhibitor 45 corresponding to a goalkeeper are displayed. In this embodiment, the central effect image 40b includes 12 types. The number of the pins 46, the size of the receiver 44, with or without the inhibitor 45 and size of the inhibitor 45 are different for each type. For example, the number of the pins 46 is same in the central effect images 40b of FIGS. 4 and 6. However, the number of the pins 46 displayed in the central effect image 40b of FIG. 5 is larger than those of the pins 46 displayed in the central effect images 40b of FIGS. 4 and 6. The size of the receiver 44 is same in the central effect images 40b of FIGS. 4 and 6. However, the size of the receiver 44 displayed in the central effect image 40b of FIG. 5 is smaller than those of the receivers 44 displayed in the central effect images 40a of FIGS. 4 and 6. The size of the inhibitor 45 is same in the central effect images 40b of FIGS. 5 and 6. However, the size of the inhibitor 45 displayed in the central effect image 40b of FIG. 4 is larger than the inhibitors 45 displayed in the central effect images 40b of FIGS. 5 and 6.

When a bonus game is started, a display is first performed in the upper effect image 40a so that a ball 41 is dropped from a side of a soccer player 47. The ball 41 is further dropped while colliding with the pins 46 and thus changing the direction. At this time, the receiver 42 and the inhibitor 43 may be respectively moved in right and left directions. When the ball 41 collides with the inhibitor 43, it is thrown away. In other words, the inhibitor 43 inhibits the ball 41 from being received in the receiver 42. When the ball 41 is received in the receiver 42, a payout is awarded and the bonus game is ended. When the ball 41 reaches a lower end of the upper effect image 40a without being received in the receiver 42, the ball 41 disappears from the upper effect image 40a and appears in an upper end of the central effect image 40b.

The ball 41 having appeared in the central effect image 40b is further dropped while colliding with the pins 46 and thus changing the direction. At this time, the receiver 44 and the inhibitor 45 may be respectively moved in right and left directions. When the ball 41 collides with the inhibitor 45, it is thrown away. In other words, the inhibitor 45 inhibits the ball 41 from being received in the receiver 44. When the ball 41 is received in the receiver 42 or reaches a lower end of the central effect image 40b, a payout is awarded and the bonus game is ended.

Like this, a bonus game is executed through a combination of the two effect images 40a, 40b.

Again referring to FIG. 1, a card reader 15 is provided to a right side of the sub display 4C. The card reader 15 reads the data from a smart card possessed by a player, or writes the data to the smart card. The sub display 4C displays the credit-number read by the card reader 15, the summed credit-number obtained by adding the credit-number acquired in a game to the corresponding credit-number, and the like. The “credit-number acquired in a game” corresponds to an amount of money that is paid out based on a display result of the center display 4B. For example, when a combination of the symbols about a winning is displayed in the center display 4B in a base game, the credit-number resulting from the combination of the symbols is added to the current credit-number. A ticket printer 14 that prints the current credit-number and the like onto a ticket is provided to a left side of the sub display 4C.

A control panel 10 that forward protrudes from the front of the cabinet 3 is provided below the sub display 4C. On the control panel 10 is arranged a button group 11 including a BET button, a start button, a stop button and the like. The BET button is pushed in betting, the start button is pushed in starting a game and the stop button is pushed to instruct the stop of the reels R1, R2, R3. In addition, the control panel 10 is provided with a coin insertion slot 12 and a bill insertion slot 13.

In the front of the cabinet 3, a sub-panel 17 is provided below the control panel 10. The sub-panel 17 is a plastic panel having a game-related image printed thereto and is outward illuminated by a cold cathode tube. A coin tray 19 that receives the coins discharged is disposed below the sub-panel 17.

In the front of the cabinet 3, protrusions 21 that are outward protruded in a bow shape are formed at both sides of the upper display 4A and the center display 4B. Side lamps 22 are arranged at the respective protrusions 21. The cabinet 3 is provided at both sides thereof with speakers 23 so that they protrude in an arc shape. Speaker lamps 24 are arranged along edges of the speakers 23. Under lamps 25 are arranged along a lower edge of the sub-panel 17. To an upper part of the upper display 4A are provided top lamps 26 including a pair of right and left lamps 26a and band-shaped lamps 26 that are horizontally arranged between the power lamps 26a.

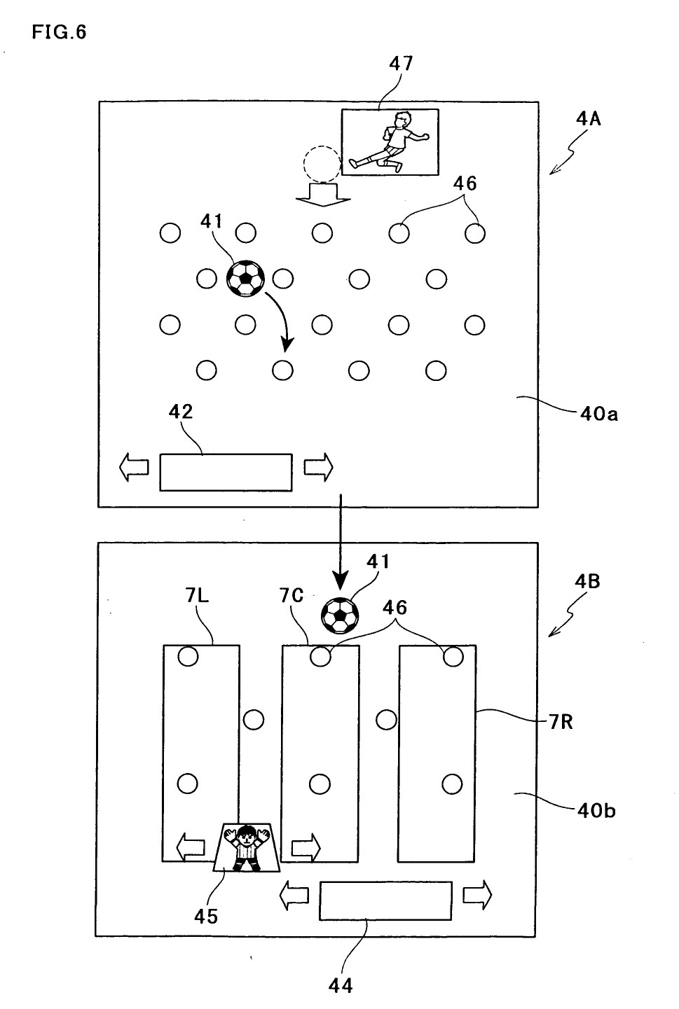

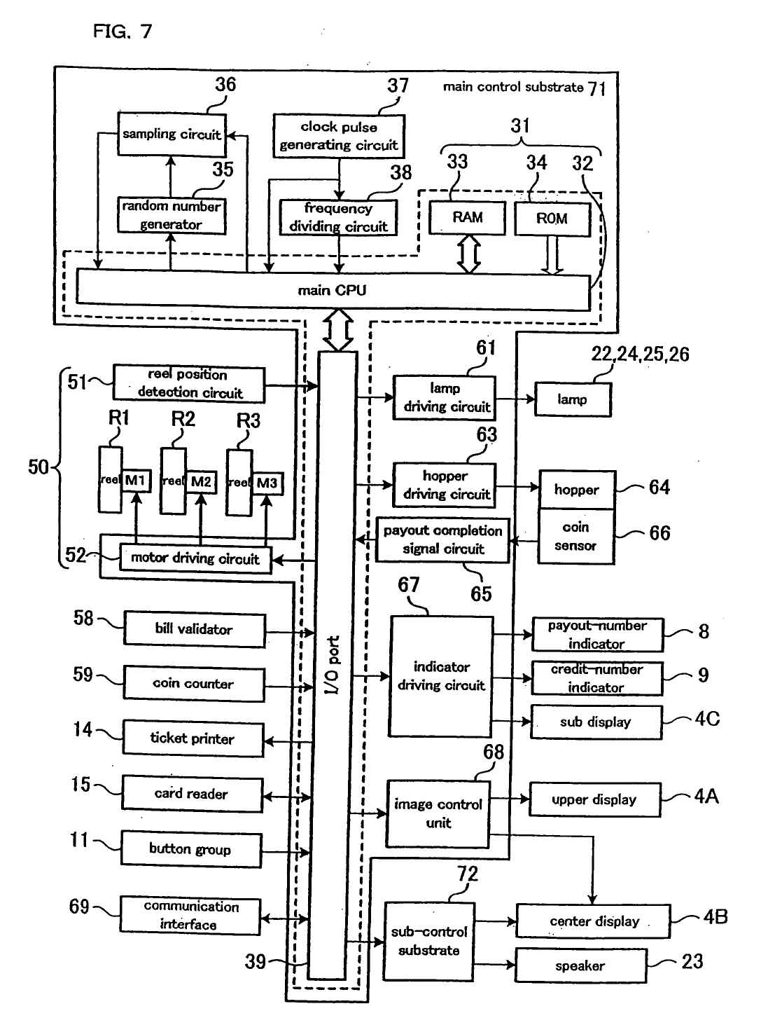

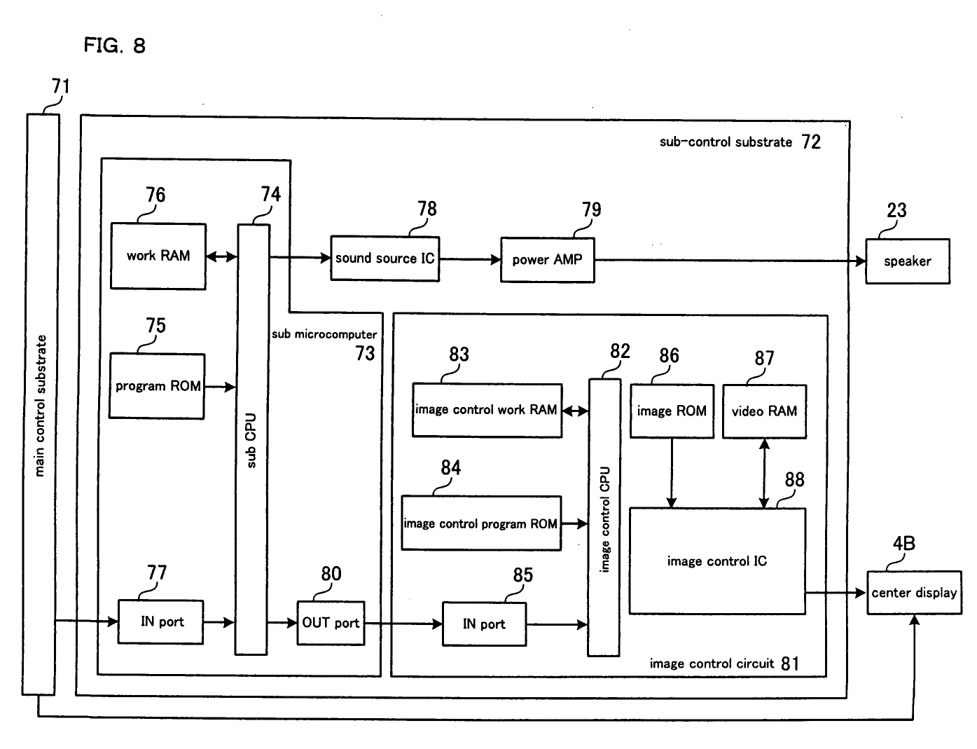

In the followings, an electrical structure of the gaming machine 1 will be described with reference to FIGS. 7 and 8. As shown in FIG. 7, the gaming machine 1 comprises a main control substrate 71. The main control substrate 71 comprises a microcomputer 71, a random number generator 35, a sampling circuit 36, a clock pulse generating circuit 37, a frequency dividing circuit 38, a lamp driving circuit 61, a hopper driving circuit 63, a payout completion signal circuit 65, an indicator driving circuit 67 and an image control circuit 68.

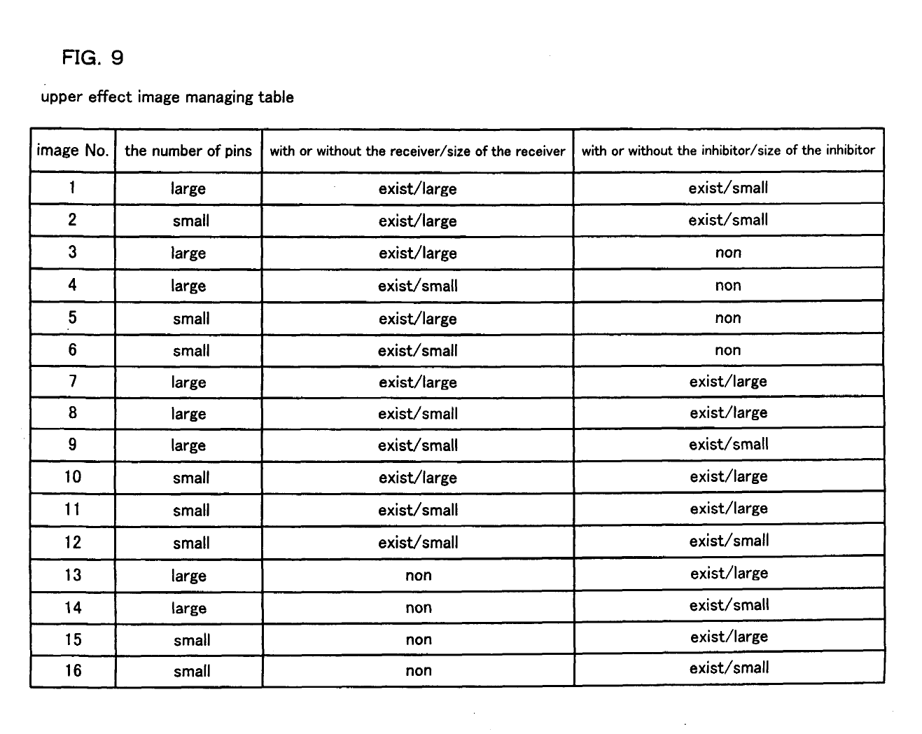

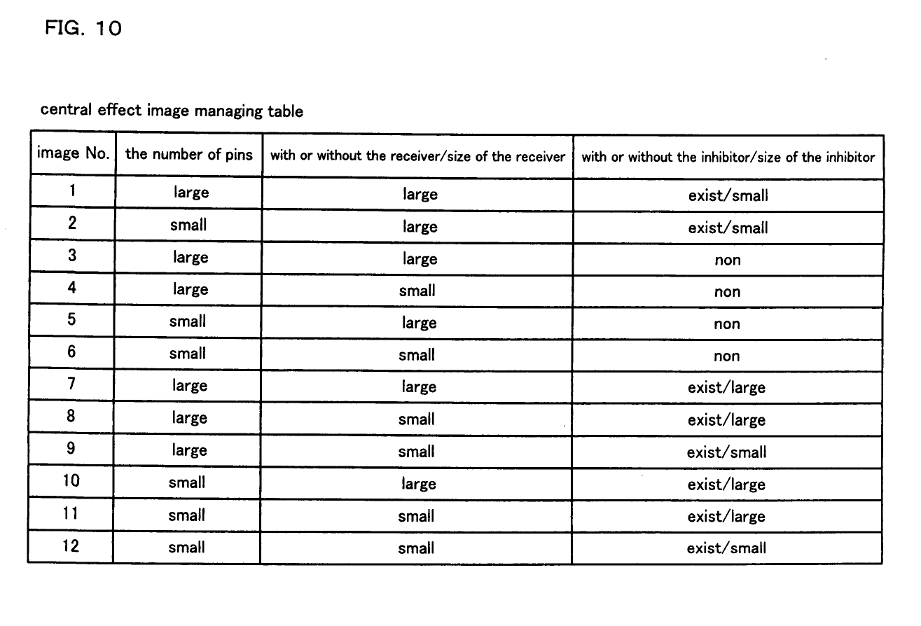

The microcomputer 31 has a main CPU 32, a RAM 33 and a ROM 34. The main CPU 32 operates in accordance with a program stored in the ROM 34 and executes an input/output of a signal to and from the other components through an I/O port 39, thereby controlling an overall operation of the gaming machine 1. The RAM 34 stores data of the symbols 180 including the code numbers, data or program that is used when the main CPU 32 operates, and the like. For example, after a game starts, the RAM 33 temporarily maintains a random number that is sampled by the sampling circuit 36. In addition, the RAM 33 stores an upper effect image managing table shown in FIG. 9 and a central effect image managing table shown in FIG. 10. The ROM 34 stores a program that is executed by the main CPU 32, permanent data and the like.

The random number generator 35 operates and generates a random number within a predetermined range, in accordance with an instruction of the main CPU 32. The sampling circuit 36 samples any random number of the random numbers that are generated by the random number generator 35 and inputs the sampled random number into the main CPU 32, in accordance with an instruction of the main CPU 32. The clock pulse generating circuit 37 generates a reference clock for operating the main CPU 32. The frequency dividing circuit 38 inputs a signal, which the reference clock is divided in a predetermined period, to the main CPU 32.

The main control substrate 71 is connected with a reel driving unit 50. The reel driving unit 50 comprises a reel position detecting circuit 51 that detects each position of the reels R1, R2, R3 and a motor driving circuit 52 that inputs a driving signal to motors M1, M2, M3 of the reels R1, R2, R3. When the driving signal is inputted from the motor driving circuit 52, the motors M1, M2, M3 are operated to rotate the reels R1, R2, R3.

The main control substrate 71 is connected with the button group 11. A signal corresponding to the push of each button included in the button group 11 is inputted into the main CPU 32 via the I/O port 39.

In addition, the main control substrate 71 is connected with a bill validator 58, a coin counter 59, a ticket printer 14, a card reader 15 and a communication interface 69.

The bill validator 58 reads an image of bill inserted into the bill insertion slot 13 and receives the normal bill in the cabinet 3. When receiving the normal bill, the bill validator 58 inputs a signal to the main CPU 32 based on an amount of the bill. The main CPU 32 having received the signal stores a credit-number in the RAM 33, which corresponds to the amount of bill.

The coin counter 59 is provided in the coin insertion slot 12 and identifies whether the coin inserted into the coin insertion slot 12 by a player is normal or not. The abnormal coin is discharged to the coin tray 19. In addition, the coin counter 59 inputs a signal to the main CPU 32 when it detects a normal coin.

The ticket printer 14 prints a barcode on a ticket, in which data stored in the RAM 33 such as credit-number, the day and time, the identification number of the gaming machine 1 and the like is coded, and outputs a ticket having the barcode attached thereto.

The card reader 15 reads the data from a smart card possessed by a player to transmit it to the main CPU 32, or writes the data to the smart card based on a control signal from the main CPU 32.

The communication interface 69 is provided to communicate with a host computer (now shown) equipped in the game arcade, through the communication line.

The lamp driving circuit 61 outputs a lighting-on or lighting-off signal to the lamps 22, 24, 25, 26 so as to perform an illumination effect.

The hopper driving circuit 63 drives a hopper 64 under control of the main CPU 32. The hopper 64 operates to discharge a coin to the coin tray 19. The payout completion signal circuit 65 is connected with the coin sensor 66. The coin sensor 66 counts the coins that are discharged as the hopper 64 is driven, thereby inputting count data to the payout completion signal circuit 65. The payout completion signal circuit 65 inputs a payout completion signal to the main CPU 32 when the discharged coin-number reaches a predetermined number, based on the count data from the coin sensor 66. The indicator driving circuit 67 controls the display operations of the payout-number indicator 8, the credit-number indicator 9 and the sub display 4C.

The image control circuit 68 controls the upper display 4A to display the upper effect image 40a and controls the center display 4B to display the central effect image 40b in a bonus game. As described above, in the upper effect image 40a and the central effect image 40b, it is displayed an image that the ball 41 is dropped while colliding with the pins 46 and an image that the receivers 42, 44 and the inhibitors 43, 45 are horizontally moved. The image control circuit 68 has an approximately same structure as an image control circuit 81 (refer to FIG. 8) included in a sub-control substrate 72.

Further, the main control substrate 71 is connected with a sub-control substrate 71. In a base game, the sub-control substrate 72 controls the display of the center display 4B and the voice output of the speakers 23. As shown in FIG. 8, the sub-control substrate 71 is a separate substrate from the main control substrate 71 and comprises a sub microcomputer 73, a sound source IC 78, a power AMP 79 serving as an amplifier and an image control circuit 81. The sound source IC 78 controls a voice sound outputted from the speakers 23. The image control circuit 81 controls the display of the center display 4B.

The sub microcomputer 73 has a sub CPU 74, a program ROM 75, a work RAM 76, an IN port 77 and an OUT port 80. The sub CPU 74 performs a control operation in accordance with a control command transmitted from the main control substrate 71. Although the sub-control substrate 72 does not have a clock pulse generating circuit, a frequency dividing circuit, a random number generator and a sampling circuit, the sub CPU 74 executes a random number sampling on the operating program. The program ROM 76 stores a control program that is executed by the sub CPU 74. The work RAM 76 temporarily stores the data when the sub CPU 74 executes the control program.

The image control circuit 81 has an image control CPU 82, an image control work RAM 83, an image control program ROM 84, an IN port 85, an image ROM 86, a video RAM 87 and an image control IC 88. The image control CPU 82 determines an image that is displayed in the center display 4B in a base game, in accordance with the image control program stored in the image control program ROM 84, based on a parameter that is set by the sub microcomputer 73.

The image control program ROM 84 stores an image control program that is related to a display in the center display 4B, or various selection tables. The image control work RAM 83 temporarily stores the data when the image control CPU 82 executes the image control program. The image control IC 88 forms an image that is determined by the image control CPU 82 and outputs it to the center display 4B.

The image ROM 86 stores dot data for forming an image. The video RAM 87 temporarily stores the data when the image control IC 88 forms the image data.

In the followings, an upper effect image managing table and a central effect image managing table will be described with reference to FIGS. 9 and 10. The upper effect image managing table and the central effect image managing table are stored in the RAM 33 of the main control substrate 71. As shown in FIG. 9, in the upper effect image managing table, each number of the upper effect images 40a having 16 types is made to correspond to the information of the respective information such as the number of the pins 46, with or without the receiver 42, the size of the receiver 42, with or without the inhibitor 43 and the size of the inhibitor 43. As shown in FIG. 10, in the central effect image managing table, each number of the central effect images 40b having 12 types is made to correspond to the information of the respective information such as the number of the pins 46, the size of the receiver 44, with or without the inhibitor 45 and the size of the inhibitor 45.

For example, in FIG. 9, in the upper effect image 40a of No. 9, the number of the pins 46 is large, the receiver 42 is provided, the size of the receiver 42 is small, the inhibitor 43 is provided and the size of the inhibitor 43 is small. In other words, the upper effect image 40a shown in FIG. 4 corresponds to No. 9. In the upper effect image 40a of No. 10, the number of the pins 46 is small, the receiver 42 is provided, the size of the receiver 42 is large, the inhibitor 43 is provided and the size of the inhibitor 43 is large. In other words, the upper effect image 40a shown in FIG. 5 corresponds to No. 10. In the upper effect image 40a of No. 3, the number of the pins 46 is large, the receiver 42 is provided, the size of the receiver 42 is large and the inhibitor 43 is not provided. In other words, the upper effect image 40a shown in FIG. 6 corresponds to No. 3.

In FIG. 10, in the central effect image 40b of No. 10, the number of the pins 46 is small, the size of the receiver 44 is large, the inhibitor 45 is provided and the size of the inhibitor 45 is large. In other words, the central effect image 40b shown in FIG. 4 corresponds to No. 10. In the central effect image 40b of No. 9, the number of the pins 46 is large, the size of the receiver 44 is small, the inhibitor 45 is provided and the size of the inhibitor 45 is small. In other words, the central effect image 40b shown in FIG. 5 corresponds to No. 9. In the central effect image 40a of No. 2, the number of the pins 46 is small, the size of the receiver 44 is large, the inhibitor 45 is provided and the size of the inhibitor 45 is small. In other words, the central effect image 40b shown in FIG. 6 corresponds to No. 2. FIGS. 4 and 5 show the effect images 40a, 40b that the ball 41 is difficult to be received in the receivers 42, 44 and FIG. 6 shows the effect images 40a, 40b that the ball 41 is easy to be received in the receivers 42, 44.

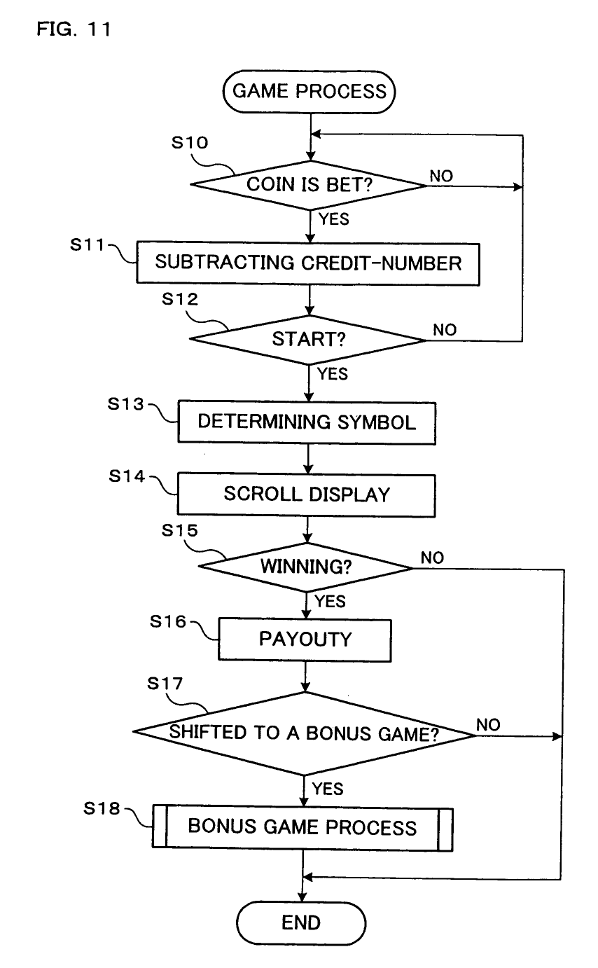

In the followings, a game process that is executed by the gaming machine 1 will be described with reference to FIG. 11. When the main CPU 32 reads out a game program stored in the ROM 34, a game process is progressed.

Firstly, the main CPU 32 determines whether a bet is made, based on whether it receives a signal accompanying with the push of the BET button (S10). When a bet is not made (S10, NO), the process of S10 is repeated. In other words, the main CPU stands by until a bet is made.

When a bet is made (S10, YES), the main CPU 32 subtracts the credit-number stored in the RAM 33 by the amount of money bet (S11). When the amount of money bet is larger than the credit-number stored in the RAM 33, or when the amount of money bet exceeds an upper limit capable of being bet in one game, i.e., maximum betting amount of money, the main CPU proceeds to a step of S12 without the step of S11 of subtracting the credit-number. In this embodiment, the maximum betting amount of money is 50.

Then, the main CPU 32 determines whether to start a game, based on whether a signal accompanying with the push of the start button is received (S12). When the start button is not pushed (S12, NO), the process is returned to the step of S10. For example, when the start button is not pushed and an instruction to end the game is inputted, the subtraction process of S10 is canceled.

When the start button is pushed (S12, YES), the main CPU 32 executes the symbol determining program stored in the ROM 34, thereby determining the symbols 180 to be stopped after the scroll display in the display windows 7L, 7C, 7R (S13).

Then, the main CPU 32 controls the center display 4B and the reels R1, R2, R3 so that the symbols 180 are scroll-displayed in the display windows 7L, 7C, 7R (S14). The main CPU 32 controls the center display 4B and the reels R1, R2, R3 so that the symbols determined in the step of S13 are stopped in the display windows 7L, 7C, 7R.

Then, the main CPU 32 determines whether a winning is made, based on whether a combination of the symbols stopped on the payline L is a predetermined combination (S15). When a winning is not made (S15, NO), this routine is ended. When a winning is made (S15, YES), a payout is awarded which corresponds to the combination of the symbols stopped on the payline L (S16).

Then, the main CPU 32 determines whether to shift the game state to a bonus game (S17). In this embodiment, when a symbol of “APPLE” is arranged on the payline L, the game state is shifted to a bonus game. When it is determined not to shift the game state to a bonus game (S17, NO), this routine is ended. When it is determined to shift the game state to a bonus game (S17, YES), a bonus game process is executed which will be described later (S18). The main CPU 32 ends this routine after executing the bonus game process.

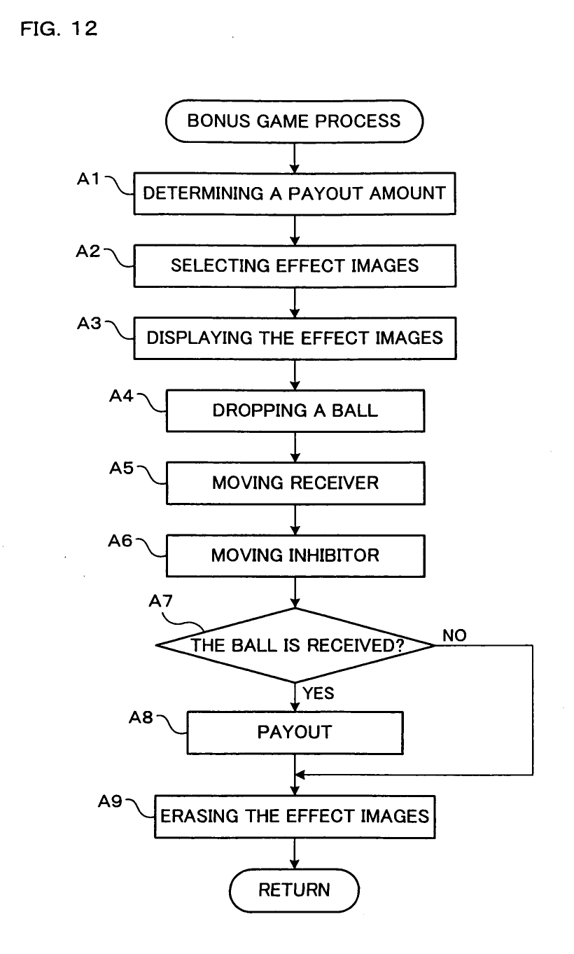

In the followings, a bonus-game process that is executed by the gaming machine 1 will be described with reference to FIG. 12.

Firstly, the main CPU 32 determines a payout in a bonus game (A1). Then, based on the payout determined in the step of A1, the main CPU selects the effect images 40a, 40b to be respectively displayed in the upper display 4A and the center display 4B while referring to the effect image managing tables shown in FIGS. 9 and 10 (A2).

To be more specific, when the payout is less than 300 credits, the main CPU selects one of the effect images 40a, 40b, which are easy to be received in the receivers 42, 44, i.e., No. 1˜No.6 shown in FIG. 9 and one of No. 1˜No. 6 shown in FIG. 10. Meanwhile, when the payout is 300 credits or more, the main CPU selects one of the effect images 40a, 40b, which are difficult to be received in the receivers 42, 44, i.e., one of No. 7˜No. 16 shown in FIG. 9 and one of No. 7˜No. 12 shown in FIG. 10.

Then, the main CPU 32 controls each of the upper display 4A and the center display 4B so that the upper effect image 40a and the central effect image 40b determined in the step of A2 are displayed (A3). Here, the ball 41 starts to be dropped in the upper effect image 40a (A4). The ball 41 is further dropped while colliding with the pins 46 and thus changing the direction. The receiver 42 and the receiver 44 are moved in right and left directions in the upper effect image 40a and the central effect image 40b, respectively (A5). In addition, the inhibitor 43 and the inhibitor 45 are moved in right and left directions in the upper effect image 40a and the central effect image 40b, respectively (A6). When the receiver 42 or the inhibitor 43, 43 is not included in the effect images 40a, 40b, the process of A5 and/or A6 may be omitted.

Then, the main CPU 32 determines whether the ball 41 is received in the receiver 42 or receiver 44 (A7). When the ball 41 is not received in any receivers 42, 44 (A7, NO), the main CPU proceeds to a step of A9. When the ball 41 is received in the receiver 42 or receiver 44 (A7, YES), the payout determined in the step of A1 is awarded (A8). Specifically, the corresponding payout is added to the credit-number that is currently stored in the RAM 33, or the coins corresponding to the payout is discharged to the coin tray 19.

Then, the main CPU 32 controls each of the upper display 4A and the center display 4B so that the effect images 40a, 40b are erased (A9). Then, this sub routine is ended.

As described above, according to the embodiment, it is displayed in the effect images 40a, 40b about the bonus game, that the ball 41 is moved while colliding with the pins 46. Thereby, even though the location is determined in advance which the ball 41 reaches, the moving direction of the ball 41 after the collision with the pins is adjusted, so that the ball 41 reaches a predetermined location in a natural moving manner. As a result, a player is impressed as if a payout were accidentally awarded, so that an interest in a game is suppressed from being lost.

In addition, the receivers 42, 44 and the inhibitors 43, 45 are also displayed in the effect images 40a, 40b. By adjusting the moving speed of the receivers 42, 44 and the inhibitors 43, 45, the movement of the ball 41 regarding whether the ball is received in the receiver 42 or receiver 44 becomes natural. As a result, a player is impressed as if a payout were accidentally awarded, so that an interest in a game is suppressed from being lost.

According to the embodiment, a new entertainment characteristic is provided.

In the mean time, it may be determined whether the ball 41 is received in the receiver 42 or receiver 44 when a bonus game is started, for example at the same time of the A1 process. In this case, based on the corresponding determined result, the movements of the ball 41, the receivers 42, 44 and the inhibitors 43, 45 are controlled. Alternatively, it may be determined whether the ball 41 is received in the receiver 42 or receiver 44 during a bonus game. To be more specific, the movements of the ball 41, the receivers 42, 44 and the inhibitors 43, 45 may be randomly controlled, so that the ball 41 is accidentally overlapped with the receiver 42 or receiver 44.

In the above embodiment, the symbols are displayed with the mechanical reels R1, R2, R3. However, the invention is not limited. For example, video reels may be used to display the symbols, or a combination of the mechanical reels and the video reels may be used to display the symbols. The vide reel may include a liquid crystal device, a CRT (cathode-ray tube) device, a plasma device and the like.

In a base game, the matrix of the symbols to be stopped after the scroll display is not limited to 3 columns/3 rows.

In the above embodiment, it is determined whether a winning is made, depending on a combination of the symbols stopped on the payline L. However, the invention is not limited thereto. For example, when a certain symbol referred to as scattered symbol is displayed in the display after the scroll display, the payout may be made in accordance with the number of the scattered symbols displayed, irrespective of the payline L.

The invention may be implemented by software, as required.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A gaming machine that provides a first game and a second game different from the first game, the gaming machine comprising:
a first display that displays a plurality of symbols and a plurality of pins;
a second display that displays a plurality of pins; and
a processor that operates:
to control the first display to variably display and then to stop the symbols in the first game;
to determine a winning of the first game in accordance with the stopped symbols;
to control each of the first and second displays to display an image that a ball is moved between the first and second displays while colliding with the pins, in the second game; and
to award a payout about the second game when the ball reaches a predetermined location.

2. A gaming machine that provides a first game and a second game different from the first game, the gaming machine comprising:
a first display that displays a plurality of symbols and a plurality of pins;
a second display that displays a plurality of pins;
a memory that stores a plurality of effect images having different conditions about the pins; and
a processor that operates:
to control the first display to variably display and then to stop the symbols in the first game;
to determine a winning of the first game in accordance with the stopped symbols;
to select, from the effect images stored in the memory, an effect image to be displayed in the first display and an effect image to be displayed in the second display, respectively, and to control each of the first and second displays to display an image that a ball is moved between the selected effect images while colliding with the pins, in the second game; and
to award a payout about the second game when the ball reaches a predetermined location.

3. A gaming machine that provides a first game and a second game different from the first game, the gaming machine comprising:
a first display that displays a plurality of symbols and a plurality of pins;
a second display that displays a plurality of pins;
a memory that stores a plurality of effect images having different conditions about the pins; and
a processor that operates:
to control the first display to variably display and then to stop the symbols in the first game;
to determine a winning of the first game in accordance with the stopped symbols;
to select, from the effect images stored in the memory, an effect image to be displayed in the first display and an effect image to be displayed in the second display, respectively, in accordance with a payout amount about the second game, and to control each of the first and second displays to display an image that a ball is moved between the selected effect images while colliding with the pins, in the second game; and
to award a payout about the second game when the ball reaches a predetermined location.

4. A gaming machine that provides a first game and a second game different from the first game, the gaming machine comprising:
a first display that displays a plurality of symbols and a plurality of pins;
a second display that displays a plurality of pins; and
a processor that operates:
to control the first display to variably display and then to stop the symbols in the first game;
to determine a winning of the first game in accordance with the stopped symbols;
to control each of the first and second displays to display an image that a ball is moved between the first and second displays while colliding with the pins and an image that a receiver is moved, in the second game; and
to award a payout about the second game when the ball reaches a predetermined location.

5. A gaming machine that provides a first game and a second game different from the first game, the gaming machine comprising:
a first display that displays a plurality of symbols and a plurality of pins;
a second display that displays a plurality of pins;
a memory that stores a plurality of effect images having different conditions about the pins and a receiver; and
a processor that operates:
to control the first display to variably display and then to stop the symbols, in the first game;
to determine a winning of the first game in accordance with the stopped symbols;
to select, from the effect images stored in the memory, an effect image to be displayed in the first display and an effect image to be displayed in the second display, respectively, and to control each of the first and second displays to display an image that a ball is moved between the selected effect images while colliding with the pins and an image that the receiver is moved, in the second game; and
to award a payout about the second game when the ball reaches a predetermined location.

6. A gaming machine that provides a first game and a second game different from the first game, the gaming machine comprising:
a first display that displays a plurality of symbols and a plurality of pins;
a second display that displays a plurality of pins;
a memory that stores a plurality of effect images having different conditions about the pins and a receiver; and
a processor that operates:
to control the first display to variably display and then to stop the symbols in the first game;
to determine a winning of the first game in accordance with the stopped symbols;
to select, from the effect images stored in the memory, an effect image to be displayed in the first display and an effect image to be displayed in the second display, respectively, in accordance with a payout amount about the second game, and to control each of the first and second displays to display an image that a ball is moved between the selected effect images while colliding with the pins and an image that the receiver is moved, in the second game; and
to award a payout about the second game when the ball reaches a predetermined location.

7. A gaming machine that provides a first game and a second game different from the first game, the gaming machine comprising:
a first display that displays a plurality of symbols and a plurality of pins;
a second display that displays a plurality of pins; and
a processor that operates:
to control the first display to variably display and then to stop the symbols in the first game;
to determine a winning of the first game in accordance with the stopped symbols;
to control each of the first and second displays to display an image that a ball is moved between the first and second displays while colliding with the pins and an image that a receiver and an inhibitor inhibiting the ball from being received in the receiver are moved, in the second game; and
to award a payout about the second game when the ball reaches a predetermined location.

8. A gaming machine that provides a first game and a second game different from the first game, the gaming machine comprising:
a first display that displays a plurality of symbols and a plurality of pins;
a second display that displays a plurality of pins;
a memory that stores a plurality of effect images having different conditions about the pins, a receiver and an inhibitor inhibiting the ball from being received in the receiver; and
a processor that operates:
to control the first display to variably display and then to stop the symbols in the first game;
to determine a winning of the first game in accordance with the stopped symbols;
to select, from the effect images stored in the memory, an effect image to be displayed in the first display and an effect image to be displayed in the second display, respectively, and to control each of the first and second displays to display an image that a ball is moved between the selected effect images while colliding with the pins and an image that the receiver and the inhibitor are moved, in the second game; and
to award a payout about the second game when the ball reaches a predetermined location.

9. A gaming machine that provides a first game and a second game different from the first game, the gaming machine comprising:
a first display that displays a plurality of symbols and a plurality of pins;
a second display that displays a plurality of pins;
a memory that stores a plurality of effect images having different conditions about the pins, a receiver and an inhibitor inhibiting the ball from being received in the receiver; and
a processor that operates:
to control the first display to variably display and then to stop the symbols in the first game;
to determine a winning of the first game in accordance with the stopped symbols;
to select, from the effect images stored in the memory, an effect image to be displayed in the first display and an effect image to be displayed in the second display, respectively, in accordance with a payout amount about the second game, and to control each of the first and second displays to display an image that a ball is moved between the selected effect images while colliding with the pins and an image that the receiver and the inhibitor are moved, in the second game; and
to award a payout about the second game when the ball reaches a predetermined location.

10. A control method of a gaming machine comprising the steps of:
controlling a first display to variably display and then to stop a plurality of symbols in a first game;
determining a winning of the first game in accordance with the symbols stopped in the first display;
controlling each of the first display and a second display different from the first display to display an image that a ball is moved between the first display and the second display while colliding with a plurality of pins, in a second game different from the first game; and
awarding a payout about the second game when the ball reaches a predetermined location.

11. A control method of a gaming machine comprising the steps of:
controlling a first display to variably display and then to stop a plurality of symbols in a first game;
determining a winning of the first game in accordance with the symbols stopped in the first display;
selecting, from a plurality of effect images having different conditions about pins, an effect image to be displayed in the first display and an effect image to be displayed in a second display different from the first display, respectively, and controlling each of the first display and the second display to display an image that a ball is moved between the selected effect images while colliding with the pins, in a second game different from the first game; and
awarding a payout about the second game when the ball reaches a predetermined location.

12. A control method of a gaming machine comprising the steps of:
controlling a first display to variably display and then to stop a plurality of symbols in a first game;
determining a winning of the first game in accordance with the symbols stopped in the first display;
selecting, from a plurality of effect images having different conditions about pins, an effect image to be displayed in the first display and an effect image to be displayed in a second display different from the first display, respectively, in accordance with a payout amount about a second game different from the first game and controlling each of the first display and the second display to display an image that a ball is moved between the selected effect images while colliding with the pins, in the second game; and
awarding a payout about the second game when the ball reaches a predetermined location.

13. A control method of a gaming machine comprising the steps of:
controlling a first display to variably display and then to stop a plurality of symbols in a first game;
determining a winning of the first game in accordance with the symbols stopped in the first display;
controlling each of the first display and a second display different from the first display to display an image that a ball is moved between the first display and the second display while colliding with the pins and an image that a receiver is moved, in a second game different from the first game; and
awarding a payout about the second game when the ball reaches a predetermined location.

14. A control method of a gaming machine comprising the steps of:
controlling a first display to variably display and then to stop a plurality of symbols in a first game;
determining a winning of the first game in accordance with the symbols stopped in the first display;
selecting, from a plurality of effect images having different conditions about pins and a receiver, an effect image to be displayed in the first display and an effect image to be displayed in a second display different from the first display, respectively, and controlling each of the first display and the second display to display an image that a ball is moved between the selected effect images while colliding with the pins and an image that the receiver is moved, in a second game different from the first game; and
awarding a payout about the second game when the ball reaches a predetermined location.

15. A control method of a gaming machine comprising the steps of:
controlling a first display to variably display and then to stop a plurality of symbols in a first game;
determining a winning of the first game in accordance with the symbols stopped in the first display;
selecting, from a plurality of effect images having different conditions about pins and a receiver, an effect image to be displayed in the first display and an effect image to be displayed in a second display different from the first display, respectively, in accordance with a payout amount about a second game different from the first game and controlling each of the first display and the second display to display an image that a ball is moved between the selected effect images while colliding with the pins and an image that the receiver is moved, in the second game; and
awarding a payout about the second game when the ball reaches a predetermined location.

16. A control method of a gaming machine comprising the steps of:
controlling a first display to variably display and then to stop a plurality of symbols in a first game;
determining a winning of the first game in accordance with the symbols stopped in the first display;
controlling each of the first display and a second display different from the first display to display an image that a ball is moved between the first display and the second display while colliding with the pins and an image that a receiver and an inhibitor inhibiting the ball from being received in the receiver are moved, in a second game different from the first game; and
awarding a payout about the second game when the ball reaches a predetermined location.

17. A control method of a gaming machine comprising the steps of:
controlling a first display to variably display and then to stop a plurality of symbols in a first game;
determining a winning of the first game in accordance with the symbols stopped in the first display;
selecting, from a plurality of effect images having different conditions about pins, a receiver and an inhibitor inhibiting a ball from being received in the receiver, an effect image to be displayed in the first display and an effect image to be displayed in a second display different from the first display, respectively, and controlling each of the first display and the second display to display an image that a ball is moved between the selected effect images while colliding with the pins and an image that the receiver and the inhibitor are moved, in a second game different from the first game; and
awarding a payout about the second game when the ball reaches a predetermined location.

18. A control method of a gaming machine comprising the steps of:
controlling a first display to variably display and then to stop a plurality of symbols in a first game;
determining a winning of the first game in accordance with the symbols stopped in the first display;
selecting, from a plurality of effect images having different conditions about pins, a receiver and an inhibitor inhibiting a ball from being received in the receiver, an effect image to be displayed in the first display and an effect image to be displayed in a second display different from the first display, respectively, in accordance with a payout amount about a second game different from the first game and controlling each of the first display and the second display to display an image that a ball is moved between the selected effect images while colliding with the pins and an image that the receiver and the inhibitor are moved, in the second game; and
awarding a payout about the second game when the ball reaches a predetermined location.
